(19) United States
(12) Patent Application Publication
(10) Pub. No.: US 2019/0191692 A1
(43) Pub. Date: Jun. 27, 2019

(54) VASCULAR ANASTOMOSIS METHOD DURING SUSTAINED PERFUSION

(71) Applicants: SCREEN HOLDINGS CO., LTD., Kyoto (JP); RIKEN, Saitama (JP)

(72) Inventors: Eiji KOBAYASHI, Kyoto (JP); Takashi TSUJI, Saitama (JP); Jun ISHIKAWA, Saitama (JP); Syuhei YOSHIMOTO, Kyoto (JP); Shinji TORAI, Kyoto (JP)

(21) Appl. No.: 16/326,578

(22) PCT Filed: Jul. 31, 2017
(86) PCT No.: PCT/JP2017/027601

§ 371 Date: Feb. 19, 2019

(30) Foreign Application Priority Data
Aug. 25, 2016 (JP) 2016-165107

(51) Int. Cl. A01N 1/02

(52) U.S. Cl. CPC A01N 1/0247

(57) ABSTRACT

For perfusion, blood vessels protruding from a removed organ or tissue and cannulas for circulating perfusate are tightened and bound at positions away from the cut ends of the blood vessels toward a proximal side viewed from the organ. The cut ends of the aforementioned blood vessels that are anastomosed to blood vessels of a living body are spaced from the binding positions at which the cannulas are secured. The direction to the blood vessels of the living body can be conducted while moving the cannulas in various postures relative to the blood vessels protruding from the organ or tissue. This enables performing an anastomosis operation while maintaining the perfusion state. In this way, organs and tissues that include at least one artery route and at least one vein route can be anastomosed to blood vessels of a living body while maintaining the perfusion state.

### TECHNICAL FIELD

The present invention relates to a method of anastomosing a blood vessel to an organ or tissue while maintaining a perfusion state of the organ or tissue.

### BACKGROUND ART

In situations such as organ transplantation and partial resection in which an organ is taken out ex vivo to resect a tumor or other sites and then returned to a living body, the organ is removed from the living body, transported, and transplanted. When such transplantation or ex vivo partial resection is performed, ischemic organs due to a blockage of the bloodstreams to the organs become a problem.

In other words, an interruption of the bloodstreams to organs creates a “warm ischemic” period. Warm ischemic organs cause cell swelling disorders due to depletion of ATP or cause accumulation of waste products such as hypoxanthine. The hypoxanthine accumulated in the cells is rapidly metabolized by oxygenated perfusate when the bloodstreams to the organs are resumed. During this process, a large amount of active oxygen may be generated and provoke tissue disorders. Also, substances such as cytokines secreted by the cells may evoke acute systemic shock in living bodies that the organs are put in and connected to.

To address this problem, for example, a method disclosed in Patent Literature 1 is proposed as a technique for preserving an organ for a long time while maintaining the function of the organ, or a technique for recovering a warm ischemic organ to a level eligible for transplantation.

### PRIOR ART DOCUMENTS

### Patent Literature

[Patent Literature 1] International Publication WO 2014/038473

### SUMMARY OF INVENTION

### Technical Problem

According to Patent Literature 1, in order to maintain or recover the function of an organ, the organ is connected to a perfusion circuit and supplied with perfusate to maintain or recover the function of the organ.

In this case, the organ removed from a donor is put in a recipient's body and connected to the perfusion circuit to continue perfusion of the organ until just before the start of anastomosis of lumens such as blood vessels. However, the organ is disconnected from the perfusion circuit and falls into a warm ischemic state at the time when the anastomosis of lumens is started. Therefore, the longer it takes to resume the bloodstreams to the organ after the organ has been put in the recipient, the greater the adverse effects of the warm ischemic state of the organ on the recipient.

In view of this, it is an object of the present invention to provide a perfusion method in which the influence of the warm ischemic state of an organ is reduced by extending a period of maintaining perfusion of the organ from when the organ has been put in a recipient to when the bloodstreams to the organ is resumed, and to provide a lumen connection method using the perfusion method.

### Solution to Problem

To solve the above-described problems, the present invention describes a perfusion method of perfusing an organ or tissue from which at least one artery and at least one vein protrude. The method includes a) a supply duct connecting step of incising or dissecting at least one of the artery and connecting thereto a supply duct for supplying perfusate to the organ or tissue, b) a discharge duct connecting step of incising or dissecting at least one of the vein and connecting thereto a discharge duct for discharging perfusate draining from the organ or tissue, and c) a perfusion step of allowing perfusate to enter from the supply duct, to pass through the organ or tissue, and to be discharged through the discharge duct. In the steps a) and b), the blood vessel and the supply duct or the discharge duct are bound at a position away from the incised or dissected site toward a proximal side viewed from the organ or tissue.

To solve the above-described problems, the present invention describes a vascular anastomosis method for anastomosis to a blood vessel of a living body while maintaining a perfusion state of an organ or tissue from which at least one artery and at least one vein protrude. The method includes a) a supply duct connecting step of incising or dissecting at least one of the artery and connecting thereto a supply duct for supplying perfusate to the organ or tissue, b) a discharge duct connecting step of incising or dissecting at least one of the vein and connecting thereto a discharge duct for discharging perfusate draining from the organ or tissue, c) a perfusion step of allowing perfusate to enter from the supply duct, to pass through the organ or tissue, and to be discharged through the discharge duct, and d) an anastomosis step of anastomosing the artery and the vein to blood vessels of a living body while maintaining the perfusion state of the organ or tissue in the step c). In the steps a) and b), the blood vessel and the supply duct or the discharge duct are bound at a position away from the incised or dissected site toward a proximal side viewed from the organ or tissue.

The step d) includes d1) a threading step of threading a suture between the artery or the vein and a blood vessel of the living body while avoiding the supply duct or the discharge duct connected to the artery or the vein, d2) a perfusion stopping step of stopping perfusion of the organ or tissue and extracting the supply duct and the discharge duct from the artery and the vein, and d3) a suture step of pulling the suture threaded between the artery or the vein and the blood vessel of the living body to suture the artery or the vein and the blood vessel of the living body.

To solve the above-described problems, the present invention describes a perfusion method of perfusing an organ or tissue from which at least one vein and at least one artery protrude. The method includes p) a supply duct connecting step of incising or dissecting at least one of the vein and connecting thereto a supply duct for supplying perfusate to the organ or tissue, q) a discharge duct connecting step of incising or dissecting at least one of the artery and connecting thereto a discharge duct for discharging perfusate draining from the organ or tissue, and r) a perfusion step of allowing perfusate to enter from the supply duct, to pass through the organ or tissue, and to be discharged through the discharge duct. In the steps p) and q), the blood vessel and the supply duct or the discharge duct are bound at a position away from the incised or dissected site toward a proximal side viewed from the organ or tissue.

To solve the above-described problems, the present invention describes a vascular anastomosis method for anastomosis to a blood vessel of a living body while maintaining a perfusion state of an organ or tissue from which at least one vein and at least one artery protrude. The method includes p) a supply duct connecting step of incising or dissecting at least one of the vein and connecting thereto a supply duct for supplying perfusate to the organ or tissue, q) a discharge duct connecting step of incising or dissecting at least one of the artery and connecting thereto a discharge duct for discharging perfusate draining from the organ or tissue, r) a perfusion step of allowing perfusate to enter from the supply duct, to pass through the organ or tissue, and to be discharged through the discharge duct, and s) an anastomosis step of anastomosing the vein and the artery to blood vessels of a living body while maintaining the perfusion state of the organ or tissue in the step r). In the steps p) and q), the blood vessel and the supply duct or the discharge duct are bound at a position away from the incised or dissected site toward a proximal side viewed from the organ or tissue.

The step s) includes s1) a threading step of threading a suture between the vein or the artery and a blood vessel of the living body while avoiding the supply duct or the discharge duct connected to the vein or the artery, s2) a perfusion stopping step of stopping perfusion of the organ or tissue and extracting the supply duct and the discharge duct from the vein and the artery, and s3) a suture step of pulling the suture threaded between the vein or the artery and the blood vessel of the living body to suture the vein or the artery and the blood vessel of the living body.

Note that the scope of the present invention also includes an invention for which one or more features of the present invention listed above are freely combined.

### Effects of the Invention

According to the invention, the ducts for supplying and discharging perfusate are secured to the blood vessels protruding from the organ or tissue, at the positions away from the cut ends of the blood vessels. This enables threading the blood vessels together with a suture while avoiding the ducts for supplying and discharging perfusate to and from the organ or tissue. The blood vessels can be sutured by extracting the ducts, with the suture threaded around the blood vessels in advance, and then pulling the suture rapidly. This reduces the influence of the warm ischemic state of the organ or tissue after the organ or tissue has been put in a living body.

### BRIEF DESCRIPTION OF DRAWINGS

FIG. 1 illustrates how donor's renal artery and renal vein are treated according to the present invention;

FIG. 2 is an enlarged view illustrating how the tip end of the donor's renal artery is treated according to the present invention;

FIG. 3 shows the condition after the treatments of a donor's kidney are completed according to the present invention;

FIG. 4 is a schematic diagram of a perfusion device according to the present invention;

FIG. 5 illustrates how the donor's kidney is anastomosed to recipient's blood vessels according to the present invention;

FIG. 6 shows the condition after the anastomosis of the donor's kidney to the recipient's blood vessels is completed according to the present invention; and

FIG. 7 illustrates how the anastomotic site is tightened according to the present invention.

### DESCRIPTION OF EMBODIMENTS

As one embodiment of the present invention, kidney transplantation is described as an example. Note that the procedure described below is also applicable to partial resection in which an organ is temporarily removed from a living body to resect a lesion such as a tumor ex vivo from the organ and then returned to the original living body.

In the present application, donors and recipients may be humans, or may be non-human animals. The non-human animals may be rodents such as mice and rats; ungulates such as pigs (including miniature swine), goats, and sheep; carnivores including dogs; non-human primates such as monkeys, baboons, and chimpanzees; and other non-human mammals such as rabbits. The non-human animals may also be non-mammalian animals.

First, a kidney graft is removed from a donor, and perfusion cannulas are inserted in the kidney graft. The removal may be conducted in the following procedure of steps (D-1) to (D-5). Although the following description is given on the treatment for the right kidney, the similar treatments may also be given to the left kidney.

(D-1)

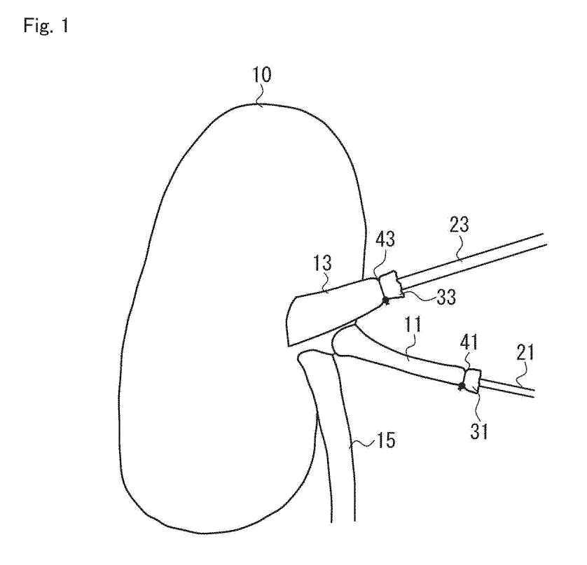

A renal artery 11, a renal vein 13, and an ureter 15 that are the lumens connected to a kidney 10 are sectioned to remove the kidney 10 from a donor (see FIG. 1).

(D-2)

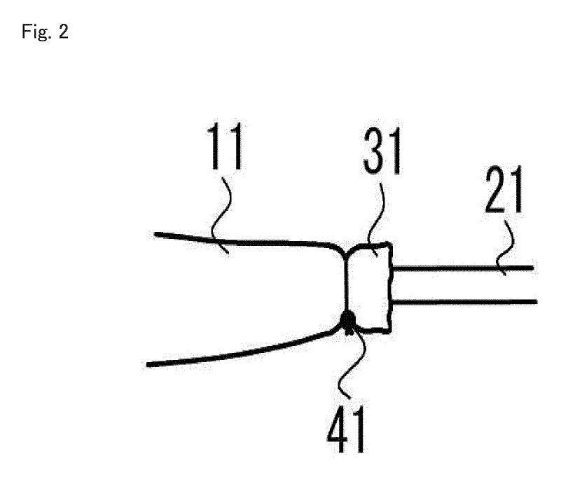

FIG. 1 illustrates how donor's renal artery 11 and renal vein 13 are treated in step (D-2). FIG. 2 is an enlarged view illustrating how the tip end of the donor's renal artery 11 is treated in step (D-2). As illustrated in FIG. 1, perfusion cannulas are connected to the removed donor's kidney 10. Specifically, a perfusate inflow cannula 21 is connected to the renal artery 11, and a perfusate outflow cannula 23 is connected to the renal vein 13.

When each cannula is connected, the blood vessel is ligated as illustrated in FIG. 2. In other words, after the cannula (perfusate inflow cannula 21 in FIG. 2) has been inserted in the blood vessel (renal artery 11 in FIG. 2), the blood vessel is ligated with a suture (suture 41 in FIG. 2) at a side proximal to the vicinity of the cut end of the blood vessel, viewed from the kidney. At this time, the blood vessel is ligated at such a position that, after the ligation, the width of the cut end of the blood vessel can be extended with tweezers or other instruments to twice or more of the outside diameter of the cannula inserted in the blood vessel. For example, the blood vessel is ligated at a position 5 mm or more away from the cut end of the blood vessel. When the blood vessel is an artery, the side of the blood vessel that is distal to the aforementioned ligated position, viewed from the kidney, is referred to as an anastomotic end region 31. When the blood vessel is a vein, the side of the blood vessel that is distal to the aforementioned ligated position, viewed from the kidney, is referred to as an anastomotic end region 33.

As described above, the renal artery 11 and the perfusate inflow cannula 21 are ligated and secured with the suture 41 at the position away from the cut end of the blood vessel. Also, the renal vein 13 and the perfusate outflow cannula 23 are ligated and secured with a suture 43 at the position away from the cut end of the blood vessel. Accordingly, when each blood vessel is anastomosed to a recipient's blood vessel described later, it is easy to thread the two blood vessels together with a suture while moving the cannulas connected to each blood vessel in various directions. This enables rapid anastomosis to the recipient's blood vessel while maintaining the perfusion state of the kidney 10.

The present embodiment describes an example in which the blood vessel is ligated with the suture 41. Alternatively, the method used to secure the cannula to the blood vessel may be other methods such as a method of pressing the blood vessel with a material such as a removable belt or an extendable band to bind the blood vessel with the cannula.

As described above, in the case of anastomosis to recipient's blood vessel, cannulas are moved in various directions during suture. Therefore, the perfusion of the kidney 10 is preferably maintained even if the renal artery 11 and the perfusate inflow cannula 21, or the renal vein 13 and the perfusate outflow cannula 23, are not arranged in a straight line (i.e., they bend at the positions ligated with the sutures 41 and 43). For this reason, for example, each cannula preferably has characteristics such that it has flexibility at least on the side proximal to the ligated position (on the side of tip end of the cannula), viewed from the kidney 10, or that its portion on the side proximal to the ligated position, viewed from the kidney 10, has a length approximately equal to or shorter than the diameter of the tip end of the cannula. The cannula also desirably has a tip end with rounded corners or has a round-shaped tip end, in order not to damage the inner wall of the blood vessel.

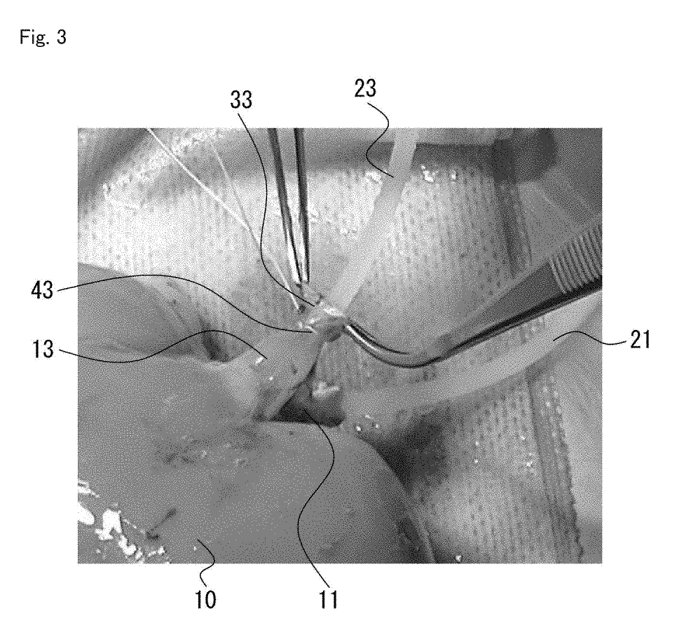

FIG. 3 illustrates the condition after the connection of the perfusate inflow cannula 21 and the perfusate outflow cannula 23 to the kidney 10 is completed and, in particular, illustrates the vicinity of the renal vein 13 in enlarge dimension. The renal vein 13 is ligated with the suture 43 for securing the perfusate outflow cannula 23, at the position away from the cut end of the renal vein 13 toward the proximal side viewed from the kidney 10. Thus, when the cut end of the renal vein 13 is extended with tweezers as illustrated in FIG. 3, the width of the opening at the cut end can be extended to twice or more of the outside diameter of the inserted perfusate outflow cannula 23.

As described above, steps (D-1) and (D-2) include a supply duct connecting step of, to perfuse a kidney that is an organ or tissue from which at least one artery and at least one vein protrude, incising or dissecting at least one (renal artery 11) of the artery and connecting thereto a supply duct (perfusate inflow cannula 21) for supplying perfusate to the kidney. Steps (D-1) and (D-2) also include a discharge duct connecting step of incising or dissecting at least one (renal vein 13) of the vein and connecting thereto a discharge duct (perfusate outflow cannula 23) for discharging perfusate draining from the kidney. In the supply duct connecting step and the discharge duct connecting step, the blood vessel and the supply duct or the discharge duct are bound at a position away from the incised or dissected site toward the proximal side viewed from the kidney.

(D-3)

The cannulas connected to the donor's kidney in the above described procedure of steps (D-1) and (D-2) are each connected to a perfusion device described later to start perfusion. In other words, perfusate is allowed to enter from the perfusate inflow cannula 21 and to drain from the perfusate outflow cannula 23.

Step (D-3) is a perfusion step of allowing perfusate to enter from the supply duct (perfusate inflow cannula 21), to pass through the kidney, and to be discharged through the discharge duct (perfusate outflow cannula 23).

In steps (D-1) to (D-3) described above, treatments that are normally given in the procedure for removing a kidney graft from a donor (e.g., excision of connective tissues, peeling of blood vessels, temporary ligation or clamping of blood vessels for section of the blood vessels, blockage and dissection of the ureter, application of coagulation agents to the kidney graft, hemostasis at operation sites) may be given as needed by those skilled in the art.

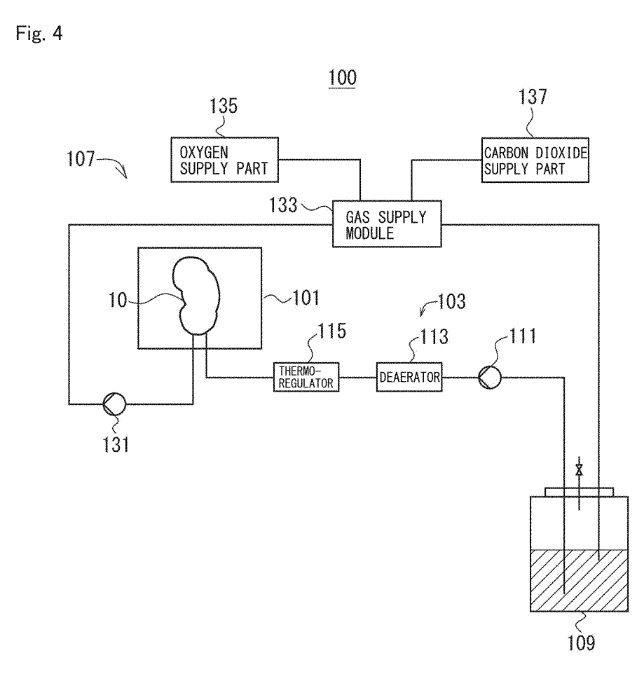

FIG. 4 illustrates one example of the perfusion device used in the present embodiment. A perfusion device 100 includes a reactor 101 that keeps the kidney 10, an inflow pathway 103 for supplying perfusate to the perfusate inflow cannula 21 connected to the renal artery 11, an outflow pathway 107 for collecting perfusate from the perfusate outflow cannula 23 connected to the renal vein 13, and a reservoir 109 that stores perfusate.

A pump 111 that conveys perfusate under pressure, a deaerator 113 that deaerates perfusate, and a thermo-regulator 115 that regulates the temperature of perfusate are interposed in the inflow pathway 103.

A pump 131 that collects perfusate from the kidney 10, and a gas supply module 133 that adds oxygen and carbon dioxide to perfusate are interposed in the outflow pathway 107. The gas supply module 133 is connected to an oxygen supply part 135 and a carbon dioxide supply part 137.

In the present invention, in addition to oxygen and carbon dioxide, nitrogen may be further added to perfusate. In this case, the gas supply module 133 is connected to a nitrogen supply part for supplying nitrogen.

The kidney 10 removed from the donor in the above-described procedure of steps (D-1) to (D-3) is connected to the perfusion device 100, kept in the reactor 101, and preserved by perfusion. Although the perfusion process according to the present embodiment is performed by circulating perfusate between the donor's kidney 10 and the perfusion device 100, the perfusion process that is performed on the donor's kidney 10 is not limited to this embodiment. In other words, other configurations may be employed, such as a configuration in which perfusate that has passed through the donor's kidney 10 is collected in a container other than the reservoir 109 or in which perfusate is disposed of directly. Alternatively, a system of conveying perfusate by gravity to the donor's kidney 10, such as a drip infusion bag, may be employed instead of the configuration of conveying perfusate under pressure with a pump as in the above-described embodiment.

Next, the donor's kidney 10 is put in the recipient. Then, vascular anastomosis is conducted in the following procedure.

(A-1)

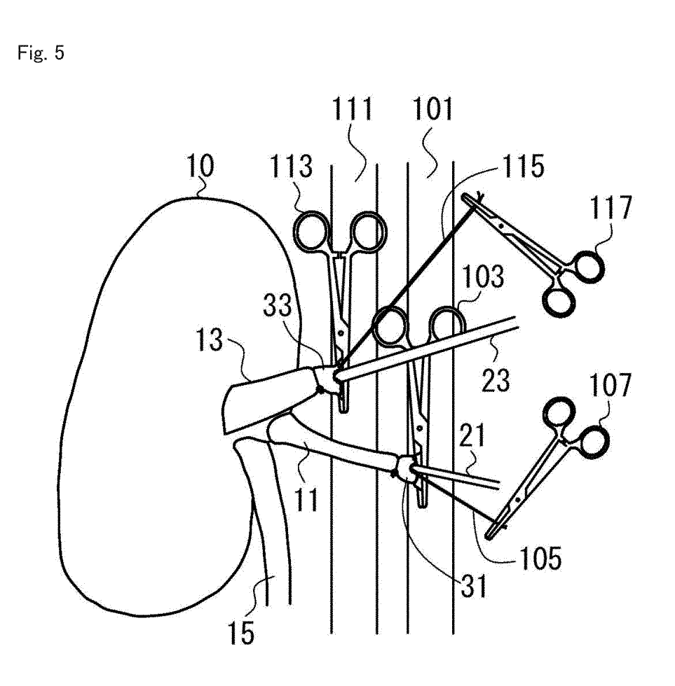

FIG. 5 illustrates how the donor's kidney is anastomosed to the recipient's blood vessels in steps (A-1) to (A-3). Hereinafter, the right side of the page in FIG. 5 is referred to as “one side,” and the left side of the page as the “other side.” First, as illustrated in FIG. 5, part of the vascular wall of an abdominal aorta 101 is pinched with vessel forceps 103 such as Satinsky forceps (side clamping) to isolate that part from the bloodstream in the blood vessel, and the vascular wall pinched with the vessel forceps 103 is incised. Similarly, part of the vascular wall of an inferior vena cava 111 is pinched with vessel forceps 113 such as Satinsky forceps (side clamping) to isolate that part from the bloodstream in the blood vessel, and the vascular wall pinched with the vessel forceps 113 is incised.

(A-2)

Next, the renal artery 11 of the donor's kidney and the recipient's abdominal aorta 101 are joined by end-to-side anastomosis. A doubly armed suture 105 is threaded with the vicinity of the cut end of the renal artery 11 on the side on which the perfusate inflow cannula 21 is placed after the anastomosis (on one side). In addition, another doubly armed suture is threaded with the opposite side of the cut end of the renal artery 11 (on the other side). Thereafter, the other side of the renal artery 11 and the vascular wall of the abdominal aorta 101 pinched with the vessel forceps 103 are continuously sutured with the doubly armed suture threaded on the other side. Subsequently, the one side of the renal artery 11 and the abdominal aorta 101, i.e., the vascular wall of the abdominal aorta 101 pinched with the vessel forceps 103, are also continuously sutured. Note that, in the case of suturing on the one side, the suture is threaded between the renal artery 11 and the abdominal aorta 101 while avoiding the perfusate inflow cannula 21 in the vicinity of the perfusate inflow cannula 21. Then, the doubly armed suture 105 is pinched with forceps 107 such as Pean's forceps and left in place at the site of operation without being tighten until the perfusate inflow cannula 21 is extracted.

(A-3)

Next, the renal vein 13 of the donor's kidney and the recipient's inferior vena cava 111 are joined by end-to-side anastomosis. A doubly armed suture 115 is threaded with the vicinity of the cut end of the renal vein 13 on the side on which the perfusate outflow cannula 23 is placed after the anastomosis (on one side). In addition, another doubly armed suture is threaded with the opposite side of the cut end of the renal vein 13 (on the other side). Thereafter, the other side of the renal vein 13 and the vascular wall of the inferior vena cava 111 pinched with the vessel forceps 113 are continuously sutured with the doubly armed suture threaded on the other side. Subsequently, the one side of the renal vein 13 and the inferior vena cava 111, i.e., the vascular wall of the inferior vena cava 111 pinched with the vessel forceps 113, are also continuously sutured. Note that, in the case of suturing on the one side, the suture is threaded between the renal vein 13 and the inferior vena cava 111 while avoiding the perfusate outflow cannula 23 in the vicinity of the perfusate outflow cannula 23. Then, the doubly armed suture 115 is pinched with forceps 117 such as Pean's forceps and left in place at the site of operation without being tighten until the perfusate outflow cannula 23 is extracted.

Even during the anastomosis of the blood vessels in the above-described procedure of steps (A-2) and (A-3), the perfusate continues to circulate from the perfusate inflow cannula 21 through the donor's kidney 10 to the perfusate outflow cannula 23. Thus, the perfusion state of the donor's kidney 10 is maintained.

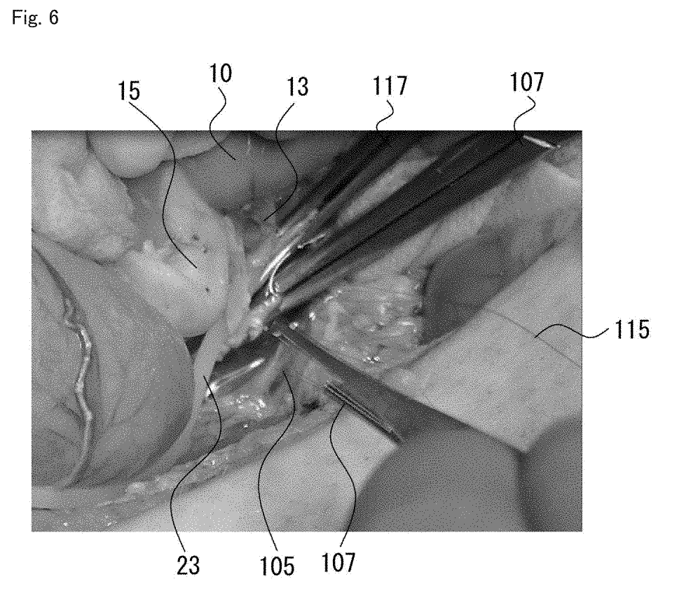

FIG. 6 illustrates the condition after the end-to-side anastomosis of the renal artery 11 to the abdominal aorta 101 and the end-to-side anastomosis of the renal vein 13 to the inferior vena cava 111 are completed in the above-described procedure of steps (A-1) to (A-3). In particular, FIG. 6 illustrates the condition in which the doubly armed suture 115 is threaded with the renal vein 13 with the perfusate outflow cannula 23 left in place, and the doubly armed suture 115 is left loose until the perfusate outflow cannula 23 is extracted.

(A-4)

Then, the perfusate inflow cannula 21 is extracted. Specifically, the suture 41 is cut, and the perfusate inflow cannula 21 is extracted. Then, the doubly armed suture 105 pinched with forceps 107 is pulled in a distal direction viewed from the kidney 10 so as to ligate the renal artery 11 and the abdominal aorta 101 while keeping them in intimate contact with each other. Subsequently, the vessel forceps 103 pinching the vascular wall of the abdominal aorta 101 is removed to resume the bloodstream to the kidney 10, and the suture site or other sites are checked for bleeding. In the case of bleeding, additional treatments such as suturing are given.

(A-5)

Then, the perfusate outflow cannula 23 is extracted. Specifically, the suture 43 is cut, and the perfusate outflow cannula 23 is extracted. Thereafter, drainage of the recipient's blood from the renal vein is awaited. When the drainage of the recipient's blood is confirmed, the doubly armed suture 115 pinched with the forceps 117 is pulled in a distal direction viewed from the kidney 10 so as to ligate the renal vein 13 and the inferior vena cava 111 while keeping them in intimate contact with each other. Then, the vessel forceps 113 pinching the vascular wall of the inferior vena cava 111 are removed to resume the bloodstream from the kidney 10 to the inferior vena cava 111, and the suture site or other sites are checked for bleeding. In the case of bleeding, additional treatments such as suturing are given.

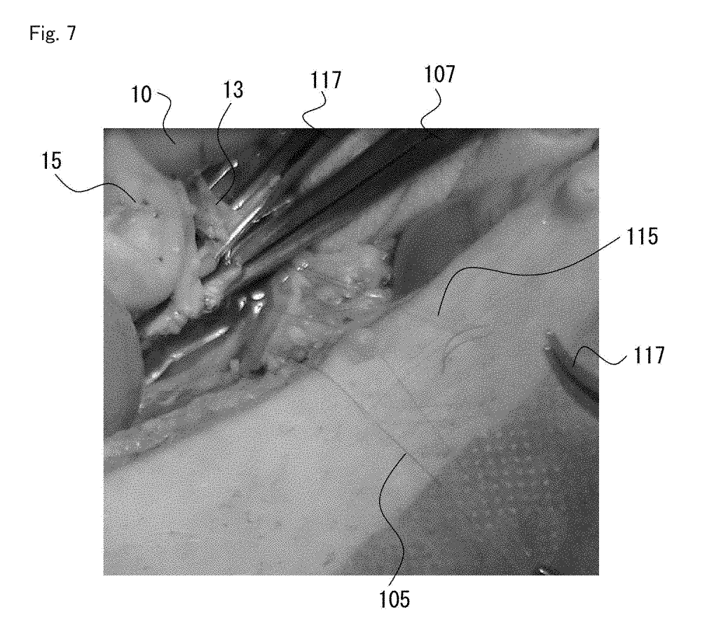

FIG. 7 illustrates the condition that the perfusate outflow cannula 23 has been extracted, and the suture site of the renal vein 13 and the inferior vena cava 111 is being tightened by pulling the doubly armed suture 115. Here, the suture site is tightened by pulling the doubly armed suture 115 with the forceps 117 in a direction away from the kidney 10 (in the right oblique downward direction in FIG. 7).

As described above, steps (A-1) to (A-5) include an anastomosis step of anastomosing an artery (renal artery 11) and a vein (renal vein 13) to blood vessels of a living body (recipient) while maintaining the perfusion state of the kidney in the perfusion step started in step (D-3).

More specifically, steps (A-2) and (A-3) include a threading step of threading a suture between the artery (renal artery 11) or the vein (renal vein 13) and a blood vessel of the living body (recipient) while avoiding the supply duct (perfusate inflow cannula 21) or the discharge duct (perfusate outflow cannula 23) connected to the artery (renal artery 11) or the vein (renal vein 13).

Steps (A-4) and (A-5) include a perfusion stopping step of stopping the perfusion of the kidney and extracting the supply duct (perfusate inflow cannula 21) and the discharge duct (perfusate outflow cannula 23) from the artery (renal artery 11) and the vein (renal vein 13). Steps (A-4) and (A-5) also include a suture step of pulling the suture threaded between the artery (renal artery 11) or the vein (renal vein 13) and the blood vessel of the living body (recipient) to suture the artery (renal artery 11) or the vein (renal vein 13) and the blood vessel of the living body (recipient).

(A-6)

Finally, the ureter 15 of the donor's kidney 10 is joined to the recipient's bladder by end-to-side anastomosis.

In the above-described procedure, the recipient's blood vessels that are anastomosed to the blood vessels of the donor's kidney may be the same type of blood vessels as the donor's blood vessels used for anastomosis, or may be a different type of blood vessels therefrom. In the case of kidney orthotopic transplantation, for example, the recipient's blood vessels that are anastomosed to the blood vessels of the donor's kidney may be the same type of blood vessels as the blood vessels of the donor's kidney used for anastomosis. In the case of kidney heterotopic transplantation, for example, the recipient's blood vessels that are anastomosed to the blood vessels of the donor's kidney may be a different type of blood vessels from the blood vessels of the donor's kidney used for anastomosis. The type of recipient's blood vessels used in kidney heterotopic transplantation can be appropriately selected on the basis of common general technical knowledge by those skilled in the art.

In the above-described procedure, treatments that are normally given in the procedure for transplanting a kidney graft into a recipient (e.g., excision of connective tissues, peeling of blood vessels, temporary ligation or clamping of blood vessels for section and anastomose of the blood vessels, anastomosis of blood vessels, hemostasis at operation sites) may be given as needed by those skilled in the art.

While the above-described embodiment employs a kidney as a target organ, the target of the present invention is not limited to the kidney. In other words, the “organ or tissue” according to the present invention is not particularly limited as long as it can be perfused. Examples of the target organ include hearts, livers, kidneys, lungs, pancreases, stomachs, small intestines, large intestines, testes, ovaries, eyeballs, teeth and their surrounding tissues, and hairs and their surrounding tissues.

In the above-described embodiment, the perfusion of an organ involves supplying perfusate to an artery and discharging the perfusate from a vein. However, the target of the present invention is not limited to this. In other words, the perfusion of an organ also includes a configuration of supplying perfusate to the vein side and discharging the perfusate from the artery side, as in Langendorff perfusion of hearts.

The shapes, structures, sizes and materials of cannulas and tubes used in the present invention are not limited, and can be appropriately selected depending on the type of blood vessel by those skilled in the art.

The composition of the perfusate used in the perfusion device of the present invention is not limited as long as it is used in the perfusion of a normal kidney graft, and commercially available perfusate (e.g., L-15 medium) may be used. Note that the perfusate is preferably supplemented with an oxygen carrier. Containing an oxygen carrier in the perfusate can suppress disorders of the kidney graft and can increase the success rate of kidney transplantation. Examples of the oxygen carrier used in the present invention include erythrocytes and artificial erythrocytes. Erythrocytes supplemented to the perfusate of the present invention are preferably erythrocytes of the blood type available for blood transfusion for the donor or the recipient, and more preferably erythrocytes derived from the donor or the recipient. Also, artificial erythrocytes supplemented to the perfusate of the present invention need only be molecules having a function of transporting oxygen, and examples thereof include perfluorocarbon and hemoglobin vesicles.

In the present invention, the “kidney graft” is not limited to the kidney removed from the donor. For example, the kidney graft may be an artificial kidney derived from stem cells such as iPS cells.

The terms as used in the specification of the present invention, unless otherwise defined particularly, are used to describe specific embodiments and do not intend to limit the invention.

Also, the term “including” as used in the specification of the present invention, unless otherwise clearly required to be understood differently by the content, intends to mean the presence of described items (such as components, steps, elements, and numbers), and does not intend to exclude the presence of other items (such as components, steps, elements, and numbers).

Unless otherwise defined, all the terms as used herein (including technical and scientific terms) have the same meanings as those broadly recognized by those skilled in the art of the technology to which the present invention pertains. The terms as used herein, unless otherwise explicitly defined, are to be construed as having meanings consistent with those in the specification of the present invention and in related technical fields, and shall not be construed as being idealized or as being interpreted as excessively formal meanings.

### REFERENCE SIGNS LIST

10 Kidney
11 Renal artery
13 Renal vein
15 Ureter
21 Perfusate inflow cannula
23 Perfusate outflow cannula
31 Anastomotic end region
33 Anastomotic end region
41 Suture
43 Suture
100 Perfusion device
101 Reactor
101 Abdominal aorta
103 Inflow pathway
103 Vessel forceps
105 Doubly armed suture
107 Outflow pathway
107 Forceps
109 Reservoir
111 Pump
111 Inferior vena cava
113 Deaerator
113 Vessel forceps
115 Thermo-regulator
115 Doubly armed suture
117 Forceps
131 Pump
133 Gas supply module
135 Oxygen supply part
137 Carbon dioxide supply part

1. A perfusion method of perfusing an organ or tissue from which at least one artery and at least one vein protrude, the method comprising:
a) a supply duct connecting step of incising or dissecting at least one of said artery and connecting thereto a supply duct for supplying perfusate to said organ or tissue;
b) a discharge duct connecting step of incising or dissecting at least one of said vein and connecting thereto a discharge duct for discharging perfusate draining from said organ or tissue; and
c) a perfusion step of allowing perfusate to enter from said supply duct, pass through said organ or tissue, and be discharged through said discharge duct,
wherein, in said steps a) and b), said artery or said vein and said supply duct or said discharge duct are bound at a position away from incised or dissected site toward a proximal side viewed from said organ or tissue.

2. A vascular anastomosis method for anastomosis to a blood vessel of a living body while maintaining a perfusion state of an organ or tissue from which at least one artery and at least one vein protrude, the method comprising:
a) a supply duct connecting step of incising or dissecting at least one of said artery and connecting thereto a supply duct for supplying perfusate to said organ or tissue;
b) a discharge duct connecting step of incising or dissecting at least one of said vein and connecting thereto a discharge duct for discharging perfusate draining from said organ or tissue;
c) a perfusion step of allowing perfusate to enter from said supply duct, to pass through said organ or tissue, and to be discharged through said discharge duct; and
d) an anastomosis step of anastomosing said artery and said vein to blood vessels of a living body while maintaining the perfusion state of said organ or tissue in said step c),
wherein, in said steps a) and b), said artery or said vein and said supply duct or said discharge duct are bound at a position away from incised or dissected site toward a proximal side viewed from said organ or tissue.

3. The vascular anastomosis method according to claim 2, wherein
said step d) includes:
d1) a threading step of threading a suture between said artery or said vein and a blood vessel of the living body while avoiding said supply duct or said discharge duct connected to said artery or said vein;
d2) a perfusion stopping step of stopping perfusion of said organ or tissue and extracting said supply duct and said discharge duct from said artery and said vein; and
d3) a suture step of pulling the suture threaded between said artery or said vein and the blood vessel of said living body to suture said artery or said vein and the blood vessel of said living body.

4. A perfusion method of perfusing an organ or tissue from which at least one vein and at least one artery protrude, the method comprising:
p) a supply duct connecting step of incising or dissecting at least one of said vein and connecting thereto a supply duct for supplying perfusate to said organ or tissue;
q) a discharge duct connecting step of incising or dissecting at least one of said artery and connecting thereto a discharge duct for discharging perfusate draining from said organ or tissue; and
r) a perfusion step of allowing perfusate to enter from said supply duct, to pass through said organ or tissue, and to be discharged through said discharge duct,
wherein, in said steps p) and q), said artery or said vein and said supply duct or said discharge duct are bound at a position away from incised or dissected site toward a proximal side viewed from said organ or tissue.

5. A vascular anastomosis method for anastomosis to a blood vessel of a living body while maintaining a perfusion state of an organ or tissue from which at least one vein and at least one artery protrude, the method comprising:
p) a supply duct connecting step of incising or dissecting at least one of said vein and connecting thereto a supply duct for supplying perfusate to said organ or tissue;
q) a discharge duct connecting step of incising or dissecting at least one of said artery and connecting thereto a discharge duct for discharging perfusate draining from said organ or tissue;
r) a perfusion step of allowing perfusate to enter from said supply duct, to pass through said organ or tissue, and to be discharged through said discharge duct; and
s) an anastomosis step of anastomosing said vein and said artery to blood vessels of a living body while maintaining the perfusion state of said organ or tissue in said step r),
wherein, in said steps p) and q), said artery or said vein and said supply duct or said discharge duct are bound at a position away from incised or dissected site toward a proximal side viewed from said organ or tissue.

6. The vascular anastomosis method according to claim 5, wherein
said step s) includes:
s1) a threading step of threading a suture between said vein or said artery and a blood vessel of said living body while avoiding said supply duct or said discharge duct connected to said vein or said artery;
s2) a perfusion stopping step of stopping perfusion of said organ or tissue and extracting said supply duct and said discharge duct from said vein and said artery; and
s3) a suture step of pulling the suture threaded between said vein or said artery and the blood vessel of said living body to suture said vein or said artery and the blood vessel of said living body.
